(19) United States
(12) Patent Application Publication
(10) Pub. No.: US 2026/0267402 A1
(43) Pub. Date: Sep. 10, 2026

(54) ELECTRONIC DEVICE, CONTROL METHOD, AND NON-TRANSITORY COMPUTER READABLE MEDIUM

(71) Applicant: CANON KABUSHIKI KAISHA, Tokyo (JP)

(72) Inventor: HIROTAKA SHINDO, Tokyo (JP)

(21) Appl. No.: 19/558,225

(22) Filed: Mar. 5, 2026

(30) Foreign Application Priority Data
Mar. 10, 2025 (JP) 2025-037594

(51) Int. Cl. G06F 3/01

(52) U.S. Cl. CPC G06F 3/011; G06F 3/016

(57) ABSTRACT

An electronic device includes a processor, and a memory storing a program which, when executed by the processor, causes the electronic device to execute acquisition processing of acquiring information indicating a plurality of movements respectively corresponding to a plurality of parts of a first user, execute selection processing of selecting any one of the plurality of movements respectively corresponding to the plurality of parts, and on a basis of the information acquired by the acquisition processing, execute control processing of relatively intensifying the movement selected by the selection processing more than a movement not selected by the selection processing, and causing a second user to feel the movement selected by the selection processing.

### BACKGROUND

### Field of the Technology

The present disclosure relates to an electronic device, a control method, and a non-transitory computer readable medium.

### Description of the Related Art

A qualitative instruction method is mainly used for transfer of skills in craft, entertainment, and the like. The qualitative instruction method typically includes precise (or fine control) related to force, movement speed, and the like. However, the qualitative instruction method takes time to transfer skills.

A method has been proposed for sensing, by using a sensor, movements of a person who transmits skills (trainer) and quantitatively transmitting, by using a haptics device, an actuator, or the like, the movements of the trainer to a person who learns the skills (trainee) on the basis of information from the sensing. Quantitative transmission improves efficiency of skill transfer.

Japanese Patent Laid-Open No. 2008-213092 proposes a technique for feeding back a reaction force received by a main operator to a subordinate operator. Japanese Patent Laid-Open No. 2000-356942 discloses a technique for teaching a user a portion looked at by an instructor or a portion to which force is applied by the instructor.

However, in a case of using the technique disclosed in Japanese Patent Laid-Open No. 2008-213092 and Japanese Patent Laid-Open No. 2000-356942, all the movements of a trainer are transmitted to a trainee, and thus, it is difficult for the trainee to grasp which movement is important. Therefore, the movements may not be effectively transmitted.

### SUMMARY

The present disclosure provides a technique for effectively transmitting a movement in a skill transfer, or the like.

The present disclosure in its first aspect provides an electronic device including a processor, and a memory storing a program which, when executed by the processor, causes the electronic device to execute acquisition processing of acquiring information indicating a plurality of movements respectively corresponding to a plurality of parts of a first user, execute selection processing of selecting any one of the plurality of movements respectively corresponding to the plurality of parts, and on a basis of the information acquired by the acquisition processing, execute control processing of relatively intensifying the movement selected by the selection processing more than a movement not selected by the selection processing, and causing a second user to feel the movement selected by the selection processing.

The present disclosure in its second aspect provides a control method of an electronic device, including executing acquisition processing of acquiring information indicating a plurality of movements respectively corresponding to a plurality of parts of a first user, executing selection processing of selecting any one of the plurality of movements respectively corresponding to the plurality of parts, and on a basis of the information acquired by the acquisition processing, executing control processing of relatively intensifying the movement selected by the selection processing more than a movement not selected by the selection processing, and causing a second user to feel the movement selected by the selection processing.

The present disclosure in its third aspect provides a non-transitory computer readable medium that stores a program, wherein the program causes a computer to execute a control method of an electronic device, the control method comprising executing acquisition processing of acquiring information indicating a plurality of movements respectively corresponding to a plurality of parts of a first user, executing selection processing of selecting any one of the plurality of movements respectively corresponding to the plurality of parts, and on a basis of the information acquired by the acquisition processing, executing control processing of relatively intensifying the movement selected by the selection processing more than a movement not selected by the selection processing, and causing a second user to feel the movement selected by the selection processing.

Features of the present disclosure will become apparent from the following description of embodiments with reference to the attached drawings. The following description of embodiments is described by way of example.

### BRIEF DESCRIPTION OF THE DRAWINGS

FIG. 1 is an overall view of a transmission system according to a first embodiment.

FIG. 2 is a system configuration diagram of the transmission system according to the first embodiment.

FIG. 3 is a flowchart of the transmission system according to the first embodiment.

FIG. 4 is an overall view of a transmission system according to a second embodiment.

FIG. 5 is a system configuration diagram of the transmission system according to the second embodiment.

FIG. 6 is a flowchart of the transmission system according to the second embodiment.

FIG. 7 is an overall view of a transmission system according to a third embodiment.

FIG. 8 is a system configuration diagram of the transmission system according to the third embodiment.

FIG. 9 is a flowchart of the transmission system according to the third embodiment.

FIG. 10 is a flowchart of the transmission system according to the third embodiment.

### DESCRIPTION OF THE EMBODIMENTS

### First Embodiment

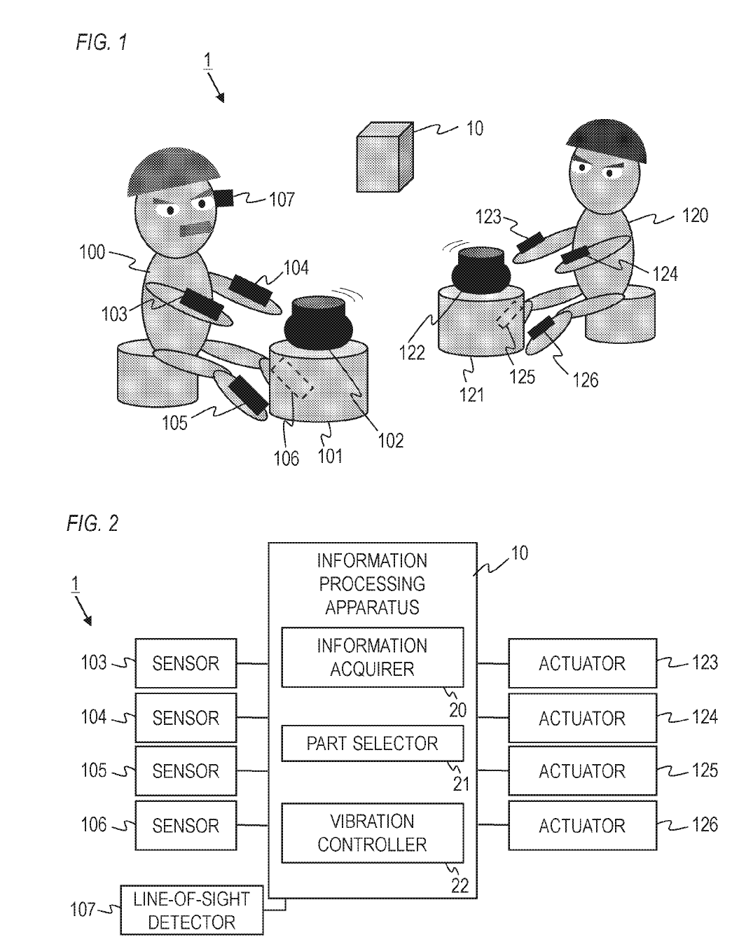

A transmission system 1 according to a first embodiment will be described with reference to FIGS. 1 to 3. In the first embodiment, when teaching how to make pottery, a person who transmits (teaches) skills (trainer 100) demonstrates exemplary movements, and the exemplary movements are transmitted to a person who learns the skills (trainee 120). At this time, if a movement of a right hand is important, by the trainer 100 gazing at the right hand, the transmission system 1 reduces transmission levels (vibration levels) of actuators attached to parts other than the right hand of the trainee 120, and performs control to intensify the movement of the right hand. However, a scene where the transmission system 1 is used is not limited to a scene where pottery is created.

FIG. 1 is an overall view of the transmission system 1 according to the first embodiment. The trainer 100 uses a pottery wheel 101 to mold clay 102 to be pottery. Four sensors 103 to 106 are attached to four parts of the trainer 100, and detect (sense) movements corresponding to the parts to which the sensors 103 to 106 are attached. The detection of the movements may be interpreted as detection of a haptic sensation (at least either of tactile sensation or kinesthetic sensation). In the first embodiment, the sensor 103 is attached to the right hand, the sensor 104 to a left hand, the sensor 105 to a right foot, and the sensor 106 to a left foot. The sensors 103 to 106 transmit information indicating detected movements (movement information) to an information processing apparatus 10. The sensors 103 to 106 include an acceleration sensor, a gyro sensor, and the like, but the sensor to be used is not particularly limited as long as movements of the trainer 100 can be detected. A strain gauge or a pressure sensor may be disposed in vicinity of a fingertip or a palm to detect fine movement of the trainer 100 or reaction force from an object. A line-of-sight detector 107 is a camera (eye tracker) that detects a line of sight of the trainer 100. The line-of-sight detector 107 transmits information indicating a detected line of sight (line-of-sight information) to the information processing apparatus 10.

The trainee 120 uses a pottery wheel 121 to mold clay 122 to be pottery. Four actuators 123 to 126 are attached to four parts of the trainee 120. The actuators 123 to 126 correspond to the sensors 103 to 106, respectively, attached to the trainer 100, and transmit, to the trainee 120, the movements detected by the sensors 103 to 106. In the first embodiment, the actuator 123 is attached to a right hand, the actuator 124 to a left hand, the actuator 125 to a right foot, and the actuator 126 to a left foot. The actuators 123 to 126 transmit the movements to the trainee 120 by vibration on the basis of the movement information transmitted from the information processing apparatus 10. However, the method for transmitting a movement to the trainee 120 is not limited to the method using the actuators 123 to 126.

The information processing apparatus 10 is a computer (electronic device) including a CPU, a memory (ROM, RAM), a storage medium, and the like. A keyboard, a mouse, and the like (not illustrated) may be connected as an input I/F to the information processing apparatus 10. The information processing apparatus 10 is wirelessly connected to the sensors 103 to 106, the line-of-sight detector 107, and the actuators 123 to 126. In the information processing apparatus 10, the CPU executes processing by reading a program stored in the ROM. Details of the processing executed by the information processing apparatus 10 will be described later.

In the first embodiment, the number of sensors attached to the trainer 100 is four, the number of line-of-sight detectors attached to the trainer 100 is one, and the number of actuators attached to the trainee 120 is four. However, the number of sensors, the number of line-of-sight detectors, and the number of actuators may be any number.

FIG. 2 is a system configuration diagram of the transmission system 1. The information processing apparatus 10 includes an information acquirer 20, a part selector 21, and a vibration controller 22. The information acquirer 20 acquires the movement information transmitted from the sensors 103 to 106 and the line-of-sight information transmitted from the line-of-sight detector 107. Based on the line-of-sight information acquired by the information acquirer 20, the part selector 21 selects a part that the trainer 100 is gazing at, from among the four parts to which the four sensors 103 to 106 are attached. This selection may be interpreted as selection of a movement corresponding to the part that the trainer 100 is gazing at, from among four movements corresponding to the four parts. Note that the method for selecting a part or a movement is not limited to the method using line-of-sight information, and, for example, the trainer 100 may select (designate) the part or the movement with a button operation or the like. The vibration controller 22 controls the actuators 123 to 126 on the basis of the movement information acquired by the information acquirer 20 and a result of the selection by the part selector 21. In the first embodiment, operations of the information acquirer 20, the part selector 21, and the vibration controller 22 are achieved by the CPU of the information processing apparatus 10 executing a program.

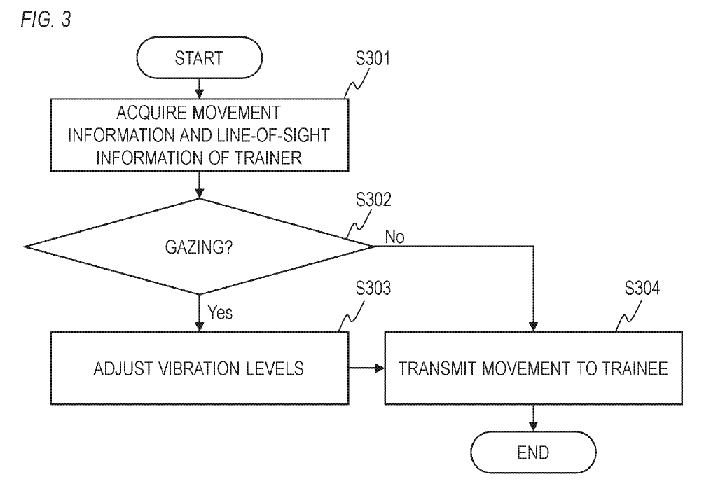

FIG. 3 is a flowchart illustrating an operation of the transmission system 1 (information processing apparatus 10). The operation in FIG. 3 is repeatedly performed.

In S301, the information acquirer 20 acquires the movement information (information indicating the exemplary movements by the trainer 100) from the sensors 103 to 106, and acquires line-of-sight information from the line-of-sight detector 107. The information acquirer 20 may store the acquired information in the memory or the storage medium.

In S302, on the basis of the line-of-sight information acquired in S301, the part selector 21 determines whether or not the trainer 100 is gazing at any one of the four parts to which the four sensors 103 to 106 are attached. When determining that the trainer 100 is gazing at any one of the four parts, the part selector 21 advances the processing to S303, and otherwise advances the processing to S304. When determining that the trainer 100 is gazing at any one of the four parts, the part selector 21 determines which part is being gazed at.

In S303, the vibration controller 22 adjusts vibration levels when the actuators 123 to 126 are operated. The vibration controller 22 adjusts the movement information acquired in S301 so as to reduce the vibration levels of the actuators corresponding to the parts other than the part being gazed at by the trainer 100. The vibration levels of the actuators corresponding to the parts other than the part being gazed at by the trainer 100 may be set to zero or may not be set to zero. The vibration level of the actuator corresponding to the part being gazed at by the trainer 100 may be increased. In that case, the vibration levels of the actuators corresponding to the parts other than the part being gazed at by the trainer 100 may not be changed.

In S304, the vibration controller 22 controls the actuators 123 to 126 attached to the trainee 120 to vibrate according to the movement information acquired in S301 or the movement information after the adjustment in S303. By performing the processing in S304, the vibration controller 22 transmits the exemplary movement of the trainer 100 to the trainee 120 to cause the trainee 120 to feel the exemplary movement.

As described above, according to the first embodiment, by relatively intensifying the selected movement more than unselected movements, intention of the trainer 100 can be effectively transmitted to the trainee 120. As a result, efficiency of skill transfer (technical guidance) can be improved. In addition, with the line-of-sight information, the trainer 100 can easily intensify the movement and transmit the movement to the trainee 120 simply by turning the line of sight to a part the movement of which is desired to be transmitted to the trainee 120.

### Second Embodiment

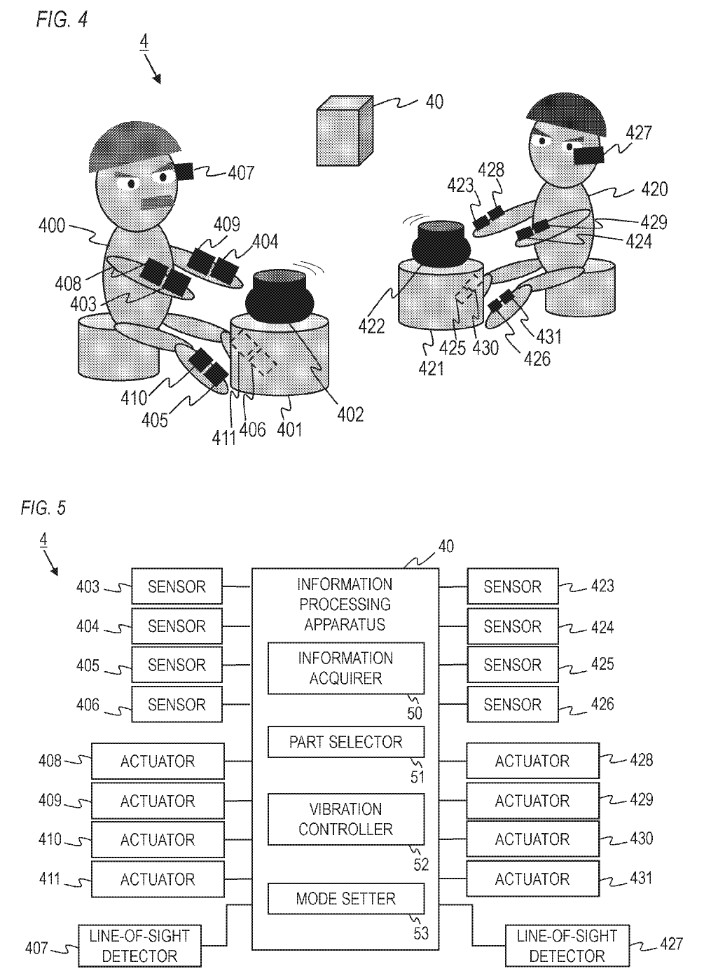

A transmission system 4 according to a second embodiment will be described with reference to FIGS. 4 to 6. In the second embodiment, as in the first embodiment, when teaching how to make pottery, a trainer 400 demonstrates exemplary movements, and the exemplary movements are transmitted to a trainee 420. Moreover, in the second embodiment, when the trainee 420 imitates the trainer 400 to make the pottery, an operation mode of a transmission system 4 can be switched so as to transmit movements of the trainee 420 to the trainer 400. However, the scene of using the transmission system 4 is not limited to a scene of making pottery.

FIG. 4 is an overall view of the transmission system 4 according to the second embodiment. The trainer 400 uses a pottery wheel 401 to mold clay 402 to be pottery. Sensors 403 to 406 are similar to the sensors 103 to 106 of the first embodiment. A line-of-sight detector 407 is similar to the line-of-sight detector 107 of the first embodiment. In the second embodiment, actuators 408 to 411 are attached to the trainer 400. The actuator 408 is attached to a right hand, the actuator 409 to a left hand, the actuator 410 to a right foot, and the actuator 411 to a left foot.

The trainee 420 uses a pottery wheel 421 to mold clay 422 to be pottery. Actuators 423 to 426 are similar to the actuators 123 to 126 of the first embodiment. In the second embodiment, sensors 428 to 431 and a line-of-sight detector 427 are attached to the trainee 420. The sensors 428 to 431 are sensors that detect movements of a trainee. The sensor 428 is attached to the right hand, the sensor 429 to a left hand, the sensor 430 to a right foot, and the sensor 431 to a left foot. The line-of-sight detector 427 is a camera (eye tracker) that detects a line of sight of the trainee 420.

An information processing apparatus 40 is substantially similar to the information processing apparatus 10 according to the first embodiment. The information processing apparatus 40 is wirelessly connected to the sensors 403 to 406 and 428 to 431, the line-of-sight detectors 407 and 427, and the actuators 408 to 411 and 423 to 426. In the information processing apparatus 40, a CPU executes processing by reading a program stored in a ROM. Details of the processing executed by the information processing apparatus 40 will be described later. Note that, in the second embodiment, there is one information processing apparatus 40 used for the transmission system 4. However, for example, two or more information processing apparatuses such as an information processing apparatus for a trainer and an information processing apparatus for a trainee may be used. In this case, the two or more information processing apparatuses may be connected to each other via the Internet or the like, and the information processing apparatus may acquire information about a remote location. With this configuration, for example, the trainer can provide technical guidance to the trainee even if the trainee is far away from the trainer.

In the second embodiment, eight sensors, two line-of-sight detectors, and eight actuators are used. However, the number of sensors, the number of line-of-sight detectors, and the number of actuators may be any number.

FIG. 5 is a system configuration diagram of the transmission system 4. The information processing apparatus 40 includes an information acquirer 50, a part selector 51, a vibration controller 52, and a mode setter 53. The information acquirer 50 acquires movement information transmitted from the sensors 403 to 406 and 428 to 431 and line-of-sight information transmitted from the line-of-sight detectors 407 and 427. The part selector 51 selects a part (movement) on the basis of the line-of-sight information acquired by the information acquirer 50. When determining that the trainer 400 is gazing at any one of four parts to which the four sensors 103 to 106 are attached, the part selector 51 selects the part that the trainer 400 is gazing at. When determining that the trainee 420 is gazing at any one of the four parts to which the four sensors 428 to 431 are attached, the part selector 51 selects the part that the trainee 420 is gazing at. Note that the part selector 51 may select a part of the trainee 420 that the trainer 400 is gazing at, or may select a part of the trainer 400 that the trainee 420 is gazing at. In the second embodiment also, the method for selecting a part or a movement is not limited to the method using line-of-sight information. The vibration controller 52 controls the actuators 408 to 411 and 423 to 426 on the basis of the movement information acquired by the information acquirer 50 and a result of the selection by the part selector 51. The mode setter 53 switches the operation mode among a plurality of modes including a teacher mode and an observation mode according to a user operation on an input I/F or the like connected to the information processing apparatus 40. The method for switching the operation mode is not particularly limited, and, for example, the operation mode may be switched on the basis of the line-of-sight information transmitted from the line-of-sight detectors 407 and 427. In the second embodiment, operations of the information acquirer 50, the part selector 51, the vibration controller 52, and the mode setter 53 of the information processing apparatus 40 are achieved by the CPU executing a program.

In the teacher mode, the vibration controller 52 controls the actuators 423 to 426 attached to the trainee 420, on the basis of the movement information from the sensors 403 to 406 attached to the trainer 400. This allows the movements of the trainer 400 to be transmitted to the trainee 420. In the observation mode, the vibration controller 52 controls the actuators 408 to 411 attached to the trainer 400, on the basis of the movement information from the sensors 428 to 431 attached to the trainee 420. This allows movements of the trainee 420 to be transmitted to the trainer 400.

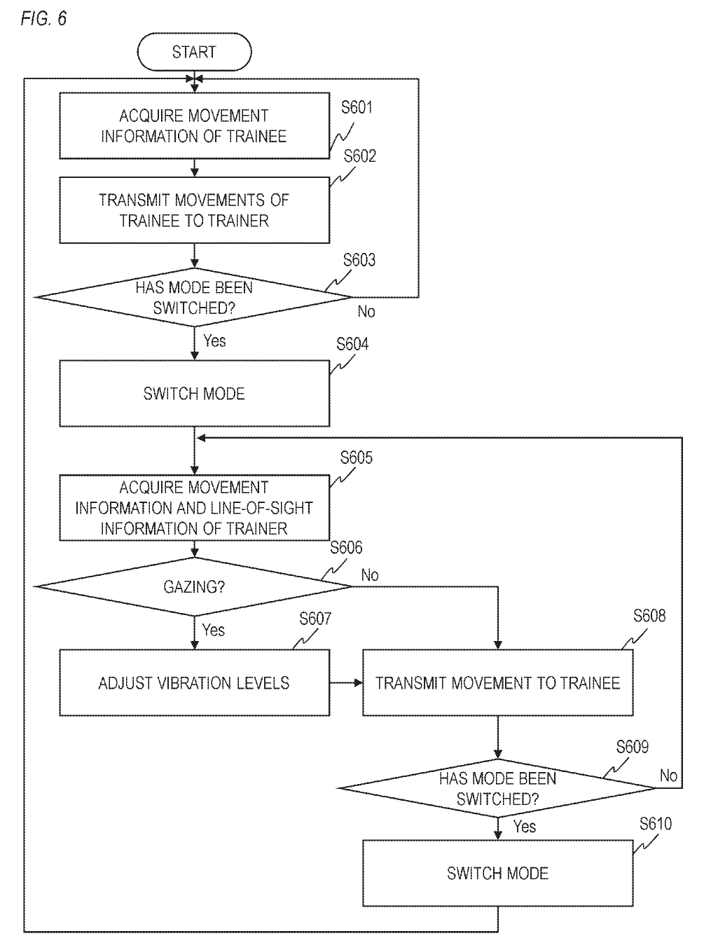

FIG. 6 is a flowchart illustrating an operation of the transmission system 4 (information processing apparatus 40). It is assumed that, at a start of the operation in FIG. 6, the trainer 400 has provided the trainee 420 with a series of instructions, and the trainee 420 is making pottery by following the instructions received. Then, it is assumed that the observation mode is set. The operation in FIG. 6 is repeatedly performed.

In S601, the information acquirer 50 acquires the movement information (information indicating the movements of the trainee 420) from the sensors 428 to 431.

In S602, the vibration controller 52 controls the actuators 408 to 411 attached to the trainer 400 to vibrate according to the movement information acquired in S601. By performing the processing in S602, the vibration controller 52 transmits the movements of the trainee 420 to the trainer 400 to cause the trainer 400 to feel the movements. Note that, in the observation mode also, as with the operation in the teacher mode (described later), movements may be transmitted by using line-of-sight information of the trainer 400 or the trainee 420.

In S603, the mode setter 53 determines whether or not a user operation for mode switching has been performed. The trainer 400 performs the user operation for the mode switching, for example, if there is any movement of the trainee 420 that requires attention. The user operation for the mode switching is not particularly limited, and may be, for example, a user operation on the input I/F or the like connected to the information processing apparatus 40. On the basis of the line-of-sight information transmitted from the line-of-sight detector 407, a movement of gazing at a predetermined position for a predetermined time may be detected as the user operation for the mode switching. When determining that the user operation for the mode switching has been performed, the mode setter 53 advances the processing to S604, and otherwise advances the processing to S601.

In S604, the mode setter 53 switches the operation mode from the observation mode to the teacher mode.

The processing in S605 to S608 is similar to the processing in S301 to S303 in FIG. 3.

In S609, the mode setter 53 determines whether or not the user operation for mode switching has been performed. When determining that the user operation for the mode switching has been performed, the mode setter 53 advances the processing to S610, and otherwise advances the processing to S605.

In S610, the mode setter 53 switches the operation mode from the teacher mode to the observation mode.

As described above, according to the second embodiment, the operation mode is switched between a plurality of modes including the observation mode and the teacher mode. With this configuration, the trainer 400 can feel an amount of force of the trainee 420 in the observation mode, and, when the amount of force is not appropriate, cause the trainee 420 to feel an amount of force of the trainer 400 in the teacher mode. This allows further improvement in efficiency of skill transfer.

### Third Embodiment

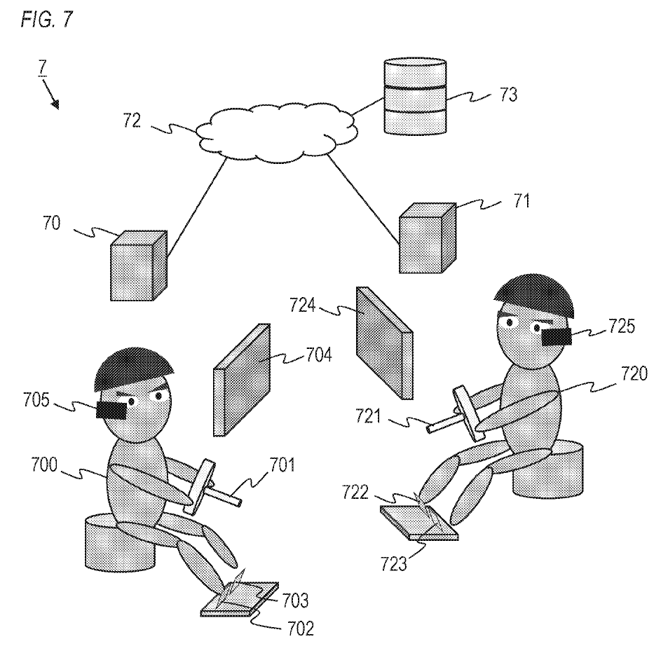

A transmission system 7 according to a third embodiment will be described with reference to FIGS. 7 to 10. In the third embodiment, an amateur racing gamer (hereinafter, amateur)720 that is a person who learns skills models his or her driving on how a professional racing gamer (hereinafter, professional) 700 that is a person who transmits the skills drives (exemplary movements) in a racing game. However, the scene of using the transmission system 7 is not limited to a scene of driving in a racing game.

FIG. 7 is an overall view of the transmission system 7 according to the third embodiment. The professional 700 performs a racing game by using a steering wheel 701, a throttle pedal 702, a brake pedal 703, a display device 704, and a line-of-sight detector 705 which are wirelessly connected to a game machine (information processing apparatus) 70. The amateur 720 performs a racing game by using a steering wheel 721, a throttle pedal 722, a brake pedal 723, a display device 724, and a line-of-sight detector 725 which are wirelessly connected to a game machine (information processing apparatus) 71.

Each of the steering wheels 701 and 721 is an operation member that changes a direction of a vehicle in a game. Each of the steering wheels 701 and 721 includes a sensor that detects an angle of the steering wheel, and an actuator that feeds back (transmits) information about exemplary movements, a road surface input received by a vehicle in the game, a sense of cornering, and the like. Each of the throttle pedals 702 and 722 is an operation member that increases speed of the vehicle in the game. Each of the throttle pedals 702 and 722 includes a sensor that detects a pedaling amount and pedaling force of the throttle pedal, and an actuator that transmits information about the exemplary movements, a state of the vehicle in the game, and the like. Each of the brake pedals 703 and 723 is an operation member that reduces speed of the vehicle in the game. Each of the brake pedals 703 and 723 includes a sensor that detects a pedaling amount and a pedaling force of the brake pedal, and an actuator that transmits information about the exemplary movements, a state of the vehicle in the game, and the like. Each of the display devices 704 and 724 is a device that displays content of the game. Each of the display devices 704 and 724 is only required to be any device having a display function, and may be a head-mounted display device or the like. The line-of-sight detector 705 is an eye tracker that detects a line of sight of the professional 700. The line-of-sight detector 725 is an eye tracker that detects a line of sight of the amateur 720. The line-of-sight detector 705 transmits acquired line-of-sight information to the game machine 70, and the line-of-sight detector 725 transmits acquired line-of-sight information to the game machine 71.

Each of the game machines 70 and 71 is a computer (electronic devices) having a CPU, a memory (ROM, RAM), a storage medium, and the like, and executes a game (game program). A controller (not illustrated) or the like may be connected to each of the game machines 70 and 71 as an input I/F. The storage medium is an SSD, a Blu-ray disk, or the like, and may be detachable from the game machine 70 or 71.

The game machine 70 is connected to the steering wheel 701, the throttle pedal 702, the brake pedal 703, the display device 704, and the line-of-sight detector 705 in a wireless or wired manner. The game machine 71 is connected to the steering wheel 721, the throttle pedal 722, the brake pedal 723, the display device 724, and the line-of-sight detector 725 in a wireless or wired manner.

The game machines 70 and 71 are connected to each other via an Internet 72. A data server 73 as a storage is connected to the Internet 72, and can transmit and receive information to and from the game machines 70 and 71. The data server 73 is a device for storing game data and information about the exemplary movements. In each of the game machines 70 and 71 and the data server 73, the CPU executes processing by reading a program stored in the storage medium such as an SSD or a Blu-ray disc. Details of the processing executed by the game machines 70 and 71 will be described later.

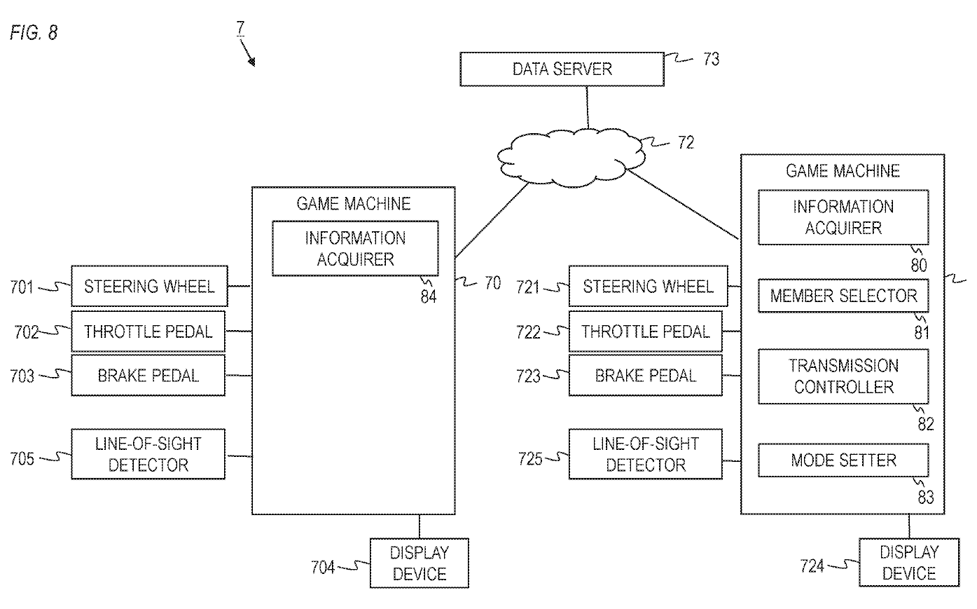

FIG. 8 is a system configuration diagram of the transmission system 7. The game machine 71 includes an information acquirer 80, a member selector 81, a transmission controller 82, and a mode setter 83. The information acquirer 80 acquires movement information transmitted from the sensors of the steering wheel 721, the throttle pedal 722, and the brake pedal 723, and line-of-sight information transmitted from the line-of-sight detector 725. The member selector 81 selects an operation member gazed at by the professional 700 from among the steering wheel 721, the throttle pedal 722, and the brake pedal 723, on the basis of the line-of-sight information acquired by the information acquirer 80. This selection may be interpreted as selection of a part gazed at by the professional 700 from among a part that operates the steering wheel 721, a part that operates the throttle pedal 722, and a part that operates the brake pedal 723. The selection may be interpreted as selection of a movement corresponding to a part gazed at by the professional 700. The transmission controller 82 controls the steering wheel 721, the throttle pedal 722, the brake pedal 723, and the display device 724 on the basis of the movement information acquired by the information acquirer 80 and a result of the selection by the member selector 81. The mode setter 83 switches a movement to be learned by the amateur 720 according to a user operation input to the line-of-sight detector 725, the input I/F connected to the game machine 71, and the like. In the third embodiment, operations of the information acquirer 80, the member selector 81, the transmission controller 82, and the mode setter 83 of the game machine 71 are achieved by the CPU executing a program.

The game machine 70 includes an information acquirer 84. The information acquirer 84 acquires movement information transmitted from the sensors of the steering wheel 701, the throttle pedal 702, and the brake pedal 703, and line-of-sight information transmitted from the line-of-sight detector 705. The information acquirer 80 stores the acquired information in the data server 73 via the Internet 72 as information about the exemplary movements. In the third embodiment, an operation of the information acquirer 84 of the game machine 70 is achieved by the CPU executing a program.

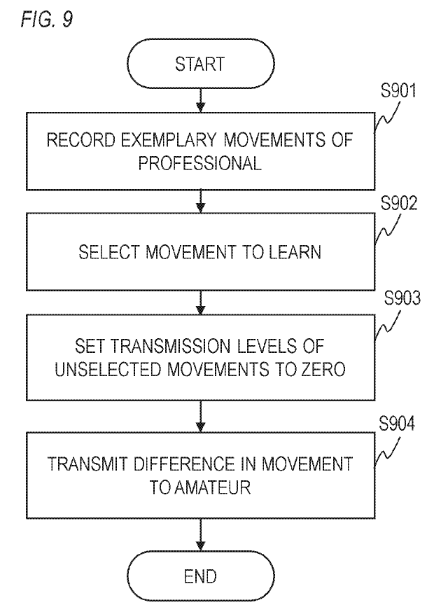

FIG. 9 is a flowchart illustrating an operation of the transmission system 7. The operation in FIG. 9 is performed, for example, in a case where a level of transmission by the actuator is set to zero for movements other than the movement to be learned by the amateur 720 (movements of the professional 700). The operation in FIG. 9 is repeatedly performed.

In S901, the information acquirer 84 acquires the movement information from the sensors of the steering wheel 701, the throttle pedal 702, and the brake pedal 703, and acquires line-of-sight information from the line-of-sight detector 705. The information acquirer 84 stores (records) the acquired information in the data server 73 via the Internet 72 as information about exemplary movements. This processing may be performed in advance. The professional 700 may perform the exemplary movements while viewing a game video of the amateur 720 at a remote location, and information may be stored in the data server 73 in real time.

In S902, the mode setter 83 receives a user operation of the amateur 720 selecting a movement wished to be learned. This user operation may be interpreted as a user operation of selecting the movement to be learned by the amateur 720. In S902, the amateur 720 uses the input I/F or the like connected to the game machine 71 to select which exemplary movement to learn from among a plurality of exemplary movements of the professional 700, the exemplary movements being stored in the data server 73.

In S903, the transmission controller 82 sets transmission levels of the movements unselected in S902 to zero. For example, in a case where the amateur 720 selects a steering operation in S902, the transmission levels of a throttle pedal operation, a brake pedal operation, and a line-of-sight position of the professional 700 are set to zero. As a result, the steering operation of the professional 700 alone is transmitted to the amateur 720.

In S904, for the movement selected in S902, the transmission controller 82 transmits a difference between the exemplary movement (movement of the professional 700) and the movement of the amateur 720 to the amateur 720. This transmission may be interpreted as transmission of a movement of the professional 700. The information acquirer 80 acquires movement information from the sensors of the steering wheel 721, the throttle pedal 722, and the brake pedal 723, and acquires line-of-sight information from the line-of-sight detector 725. The transmission controller 82 compares movement information of the professional 700 stored in the data server 73 with movement information of the amateur 720 acquired by the information acquirer 80, and calculates a difference between the movements. The transmission controller 82 controls the actuators of the steering wheel 721, the throttle pedal 722, and the brake pedal 723 on the basis of the calculated difference between the movements, thereby transmitting the exemplary movement of the professional 700 to cause the amateur 720 to feel the exemplary movement. Note that the method for transmitting an exemplary movement of the professional 700 to the amateur 720 is not limited to the method for controlling the actuators, and for example, the display device 724 may perform display based on the calculated difference. Information to be displayed may be information about all the movements, or may be information about the movement selected in S902 alone. For the line-of-sight information, a difference between a line-of-sight position of the professional 700 and a line-of-sight position of the amateur 720 may be calculated and displayed on the display device 724 based on the difference, or an item indicating the line-of-sight position of the professional 700 may be displayed on the display device 724.

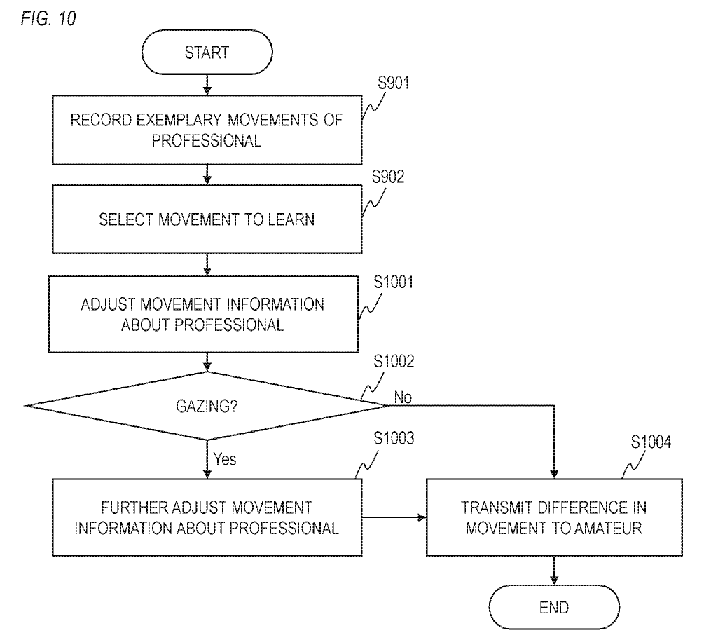

FIG. 10 is a flowchart illustrating another operation of the transmission system 7. The operation in FIG. 10 is performed in a case where a level of transmission by the actuator is set to be intensified for the movement to be learned by the amateur 720 (movement of the professional 700). The operation in FIG. 10 is repeatedly performed.

In S1001, the transmission controller 82 acquires movement information (which may include line-of-sight information) of the professional 700, the movement information being stored in the data server 73. Then, the transmission controller 82 adjusts the movement information of the professional 700 so that the movement selected in S902 is relatively intensified more than the unselected movements. For example, when the amateur 720 selects the steering operation in S902, the transmission controller 82 performs control so as to intensify an exemplary operation of steering. Thus, the transmission by the steering wheel 721 to the amateur 720 is intensified.

In S1002, the member selector 81 determines whether or not the amateur 720 is gazing at any one of the plurality of operation members (the steering wheel 721, the throttle pedal 722, and the brake pedal 723), on the basis of the line-of-sight information acquired from the line-of-sight detector 725. When determining that the amateur 720 is gazing at any one of the plurality of operation members, the member selector 81 advances the processing to S1003, and otherwise advances the processing to S1004. When determining that the amateur 720 is gazing at any one of a plurality of parts, the member selector 81 determines which operation member is being gazed at. Note that the member selector 81 may detect, for example, that the amateur 720 is gazing at a virtual steering wheel (not illustrated), a virtual pedal (not illustrated), or the like displayed on the display device 724.

In S1003, the transmission controller 82 further adjusts the movement information of the professional 700 so as to relatively intensify operation of the operation member that the amateur 720 is gazing at more than operation of the operation members that the amateur 720 is not gazing at. For example, the transmission controller 82 adjusts the movement information of the professional 700 so as to reduce a transmission level of an operation by the professional 700 for operation members other than the operation member that the amateur 720 is gazing at.

In S1004, the transmission controller 82 transmits, to the amateur 720, a difference between the movement of the professional 700 after adjustment in S1001 or the movement of the professional 700 after adjustment in S1003 and the movement of the amateur 720. The information acquirer 80 acquires movement information from the sensors of the steering wheel 721, the throttle pedal 722, and the brake pedal 723, and acquires line-of-sight information from the line-of-sight detector 725. The transmission controller 82 compares movement information (and line-of-sight information) of the professional 700 after the adjustment in S1001 (and in S1003) with movement information (and line-of-sight information) of the amateur 720 acquired by the information acquirer 80, and calculates a difference between the movements. The transmission controller 82 controls the actuators of the steering wheel 721, the throttle pedal 722, and the brake pedal 723 on the basis of the calculated difference, thereby transmitting the exemplary movement of the professional 700 to cause the amateur 720 to feel the exemplary movement. For example, by controlling the actuator of the steering wheel 721 on the basis of a difference in the steering operation, it is possible to cause the amateur 720 to feel a steering operation of the professional 700. Similarly, by controlling the actuator of the throttle pedal 722 on the basis of a difference in the throttle pedal operation, it is possible to cause the amateur 720 to feel a throttle pedal operation of the professional 700. By controlling the actuator of the brake pedal 723 on the basis of a difference in the brake pedal operation, it is possible to cause the amateur 720 to feel the brake pedal operation of the professional 700. Note that the method for transmitting an exemplary movement of the professional 700 to the amateur 720 is not limited to the method for controlling the actuators, and for example, the display device 724 may perform display based on the calculated difference.

As described above, according to the third embodiment, information about model driving (exemplary movement) of the professional 700 is recorded, and a part of the steering operation, the throttle pedal operation, and the brake pedal operation is relatively intensified and transmitted to the amateur 720. In this way, the amateur 720 can effectively learn a part of the exemplary movements of the professional 700, and the learning efficiency of the amateur 720 can be improved.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to effectively transmit a movement in a skill transfer, or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037594, filed Mar. 10, 2025, which is hereby incorporated by reference herein in its entirety.

What is claimed is:

1. An electronic device comprising:
a processor; and
a memory storing a program which, when executed by the processor, causes the electronic device to
execute acquisition processing to acquire information indicating a plurality of movements respectively corresponding to a plurality of parts of a first user,
execute selection processing to select any one of the plurality of movements respectively corresponding to the plurality of parts, and
execute, based on the information acquired by the acquisition processing, control processing that relatively intensifies the movement selected by the selection processing more than a movement not selected by the selection processing, and causing a second user to feel the movement selected by the selection processing.

2. The electronic device according to claim 1,
wherein, in the acquisition processing, a plurality of pieces of information respectively corresponding to the plurality of movements are acquired from a storage.

3. The electronic device according to claim 1,
wherein, when the program is executed by the processor, the program further causes the electronic device to execute setting processing that sets any one of a plurality of modes including a first mode and a second mode, wherein
in the acquisition processing, in the first mode, information indicating a plurality of movements respectively corresponding to a plurality of parts of the first user is acquired, and, in the second mode, information indicating a plurality of movements respectively corresponding to a plurality of parts of the second user is acquired, and
in the control processing, in the first mode, control is performed so as to cause the second user to feel a movement of the first user, based on information acquired by the acquisition processing, and, in the second mode, control is performed so as to cause the first user to feel a movement of the second user, based on information acquired by the acquisition processing.

4. The electronic device according to claim 1,
wherein, in the selection processing, a selection is performed to select a movement corresponding to a part to which a line of sight of the first user or the second user is directed.

5. The electronic device according to claim 1,
wherein, in the control processing, control is performed so as to display, on a display device, the plurality of movements indicated by the information acquired by the acquisition processing.

6. The electronic device according to claim 1,
wherein, in the acquisition processing, information indicating a plurality of movements respectively corresponding to a plurality of parts of the second user is further acquired, and
in the control processing, control is performed so as to cause the second user to feel a difference between a movement of the first user and a movement of the second user after relatively intensifying a movement of the first user selected by the selection processing more than a movement not selected by the selection processing.

7. The electronic device according to claim 1,
wherein, in the control processing, control is performed to exclusively teach a movement selected by the selection processing.

8. A control method of an electronic device, comprising:
executing acquisition processing of acquiring information indicating a plurality of movements respectively corresponding to a plurality of parts of a first user;
executing selection processing of selecting any one of the plurality of movements respectively corresponding to the plurality of parts; and
on a basis of the information acquired by the acquisition processing, executing control processing of relatively intensifying the movement selected by the selection processing more than a movement not selected by the selection processing, and causing a second user to feel the movement selected by the selection processing.

9. A non-transitory computer readable medium that stores a program, wherein the program causes a computer to execute a control method of an electronic device, the control method comprising:
executing acquisition processing of acquiring information indicating a plurality of movements respectively corresponding to a plurality of parts of a first user;
executing selection processing of selecting any one of the plurality of movements respectively corresponding to the plurality of parts; and
on a basis of the information acquired by the acquisition processing, executing control processing of relatively intensifying the movement selected by the selection processing more than a movement not selected by the selection processing, and causing a second user to feel the movement selected by the selection processing.
